(19) United States
(12) Patent Application Publication
(10) Pub. No.: US 2006/0046732 A1
(43) Pub. Date: Mar. 2, 2006

(54) Traffic channel

(75) Inventors: Joel K. Grossman, Seattle, WA (US); Kent H. Skinner, Kirkland, WA (US); Albert W. Tan, Redmond, WA (US); Burdette Holtgrewe, Bellevue, WA (US); Christian James Colando, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/926,116

(22) Filed: Aug. 24, 2004

(51) Int. Cl. H04Q 7/20

(52) U.S. Cl. 455/450

(57) ABSTRACT

The present invention provides a traffic channel to a user on a mobile device. Traffic content associated with a traffic channel is automatically delivered and stored on a mobile electronic device for access by a user. Using the device, users can quickly access the traffic information without having to type in information, or specifically request the information to be downloaded to the device. The traffic channel provides a quicker and less cumbersome way of accessing traffic information customized for the user than having to access a web site, a television, a radio station, or a telephone service.

### BACKGROUND OF THE INVENTION

Mobile electronic devices, such as cell phones, wireless PDAs, wireless laptops and other mobile communication devices are making impressive inroads with consumers. Many of the mobile electronic devices are able to perform a variety of tasks and include a user interface to help the user access the features associated with the device. For example, some mobile devices include a display unit that displays graphical data to support email, instant messaging, web browsing, and other non-voice features. Using their mobile devices, users access the Internet, send and receive email, participate in instant messaging, and perform other operations. Accessing the desired information, however, may be cumbersome for the user. When accessing the Internet, for instance, users have to log onto the network and then type in information to access the information they desire. Additionally, using the user interface on the mobile device may be difficult. For instance, mobile devices typically do not have a good mechanism for inputting data.

### SUMMARY OF THE INVENTION

The present invention is directed at providing a traffic channel to a user on a mobile device.

According to one aspect of the invention, traffic based content associated with a traffic channel is automatically delivered and stored on a mobile electronic device for access by a user. Using the device, users can quickly access traffic information without having to type in information, or specifically request the information to be downloaded to the device. The traffic channel is directed at providing a quicker and less cumbersome way of accessing personalized traffic information than having to access a web site, a television, a radio station, or a telephone service.

According to another aspect of the invention, the traffic channel includes several different displays for showing different types of travel information. Some travel information that may be displayed includes: average and actual travel times for selected routes; traffic flow and conditions; and traffic incident reports.

According to yet another aspect of the invention, the user may customize the travel information they receive. For example, the user may select to receive traffic information for certain routes and traffic alerts for specific areas in their region.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 illustrates an operating environment;

FIG. 2 shows an electronic device;

FIG. 3 illustrates an exemplary smart object watch devices that include a user interface for navigating through channels and content;

FIG. 4 illustrates a system for delivering and configuring channel information to an electronic device;

FIGS. 5A-5D illustrate process flows for passive and active navigation functions of a electronic device;

FIG. 6 shows exemplary status indicator headers;

FIG. 7 shows an exemplary traffic channel;

FIG. 8 shows glance views associated with a my routes mode for a traffic channel;

FIG. 9 illustrates traffic conditions;

FIG. 10 illustrates detail views for the traffic channel;

FIGS. 11-14 illustrate web user interfaces for customizing the traffic channel;

FIG. 15 illustrates displays for traffic alerts and drive times; and

FIG. 16 illustrates encoding data, in accordance with aspects of the present invention.

### DETAILED DESCRIPTION OF THE PREFERRED EMBODIMENT

The apparatus, system, and method of the present invention are related to navigating through a traffic channel on a device that includes stored traffic information. Content that is associated with the traffic channel may be selected and viewed on a display of the device by means of passive interaction (e.g., hands free operation) or active interaction (e.g., selecting buttons).

In the described embodiments, the electronic devices may be mobile devices, such as smart watches, that are specially configured to receive communication signals. The electronic devices may be configured to receive broadcast transmissions from one or more broadcast towers and are capable of receiving and processing messages from the broadcast transmissions. The electronic devices store the received information such that the information is indexed according to designated channels. Each channel includes content that is organized according to a set of criteria. For example, traffic content is presented in one channel; wherein news content is presented in another channel. Some channels may include content from one or more of the other channels. For example, the traffic channel may present some information, such as traffic alerts, in another channel, such as a message channel or a news channel. After information is received and processed by the client device, a user may passively or actively review the information that is stored in the electronic device.

One of the particular channels corresponds to a traffic channel. The traffic channel on each device may be customized based on user preferences such that the user experience is enhanced. An example traffic channel may be configured to display information relating to certain traffic routes that a user has selected.

Although described here in the context of a watch-based system, other mobile or non-mobile devices, such as portable and desktop computers, personal digital assistants (PDAs), cellular telephones, and the like, may be used. The use of a watch is for illustrative purposes only to simplify the following discussion, and may be used interchangeably with “mobile device” and/or “electronic device”.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

Exemplary Smart Object Device

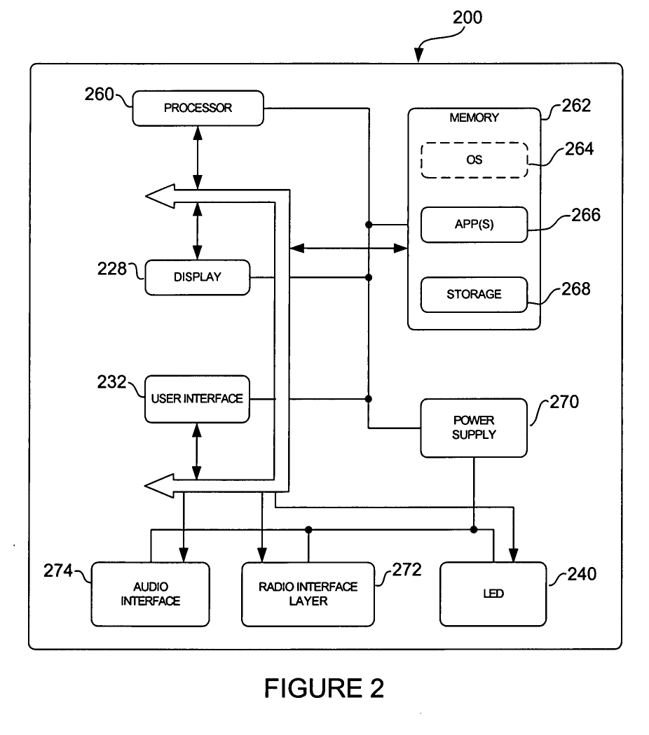

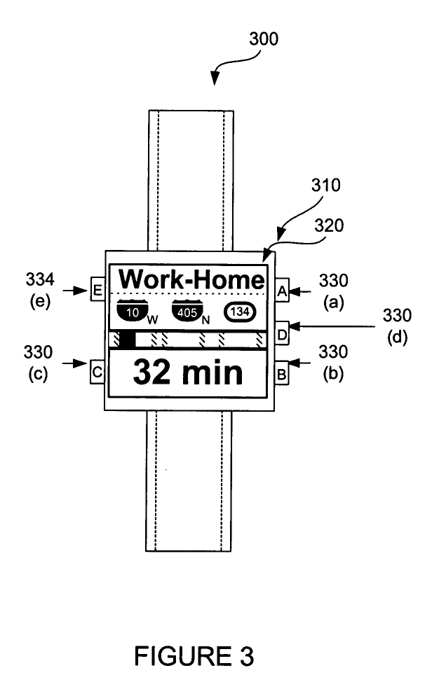

FIG. 3 illustrates an exemplary smart device that includes a user interface that is configured to interact with content from channels, in accordance with aspects of the invention. Watch device 300 includes bezel 310 which has an electronic system. The electronic system performs the functions in a manner that is consistent with the hardware that is described with respect to FIG. 2. Bezel 310 includes display 320, such as a liquid crystal display, a multiple bit display, or a full color display. In one embodiment, watch hands are electronically generated on display 320 when the user is in a time mode. In an alternative embodiment, the bezel includes analog-type watch hands that do not detrimentally interfere with display 320. As illustrated, display 320 shows travel information for a selected route.

Watch device 300 includes a series of selectors, such as buttons A-D (330a-d), which are arranged to operate as part of a user interface (UI). Each selector may have a default function and/or a context determined function. The currently selected channel determines the context for each selector. Alternatively, the currently active display may determine the context for each selector. For example, a display screen (e.g., a help screen) may be superimposed on the main display such that the display screen becomes the active context. Watch device 300 is context sensitive in that the function that is associated with each selector may change based on the selected channel or display screen.

Button “A” has a default function of page up or previous page in the currently selected channel. Button “A” may also have an alternate function based on the currently selected channel or display. For example, button “A” may be configured to activate a speed list browse function after button “A” is activated for a predetermined time interval. In the speed list browse function, a pop-up visual cue (e.g., a pop-up window) may be used to indicate how that list is indexed. Each record (e.g., a list of routes, a list of indexes, etc.) can be indexed many different ways, including by price, alphabetically, by date, categories, or any other way of indexing a record. List browse indexing allows a user to quickly access records located within the list.

Button “B” has a default function of page down or next page in the currently selected channel. Button “B” may also have an alternate function based on the currently selected channel or display. In one example, button “B” is activated for a predetermined time interval (e.g., two seconds) to select a “speed list browse” function.

Button “C” has a default function of next channel. Button “C” may also have an alternate function based on the currently selected channel or display. In one example, button “C” is activated for a predetermined time interval (e.g., two seconds) to select the main channel or “primary” channel. The main channel in an example watch device is the time channel that provides the user with time related information. However, devices may be configured to have some other display screen that is recognized by the device as a “primary” channel or “home” location.

Button “D” has a default (or “primary”) function of “enter.” The “enter” function is context sensitive and used to select the “enter” function within a selected channel (e.g., enter a details view), or to select an item from a selection list (e.g., select a route within the my routes list browse). Button “D” may also have an alternate function based on the currently selected channel or display. For example, the “D” selector is activated for a predetermined time interval (e.g., two seconds) to activate a delete function. In another example, the “D” button may be selected for a predetermined time to activate a help screen or an additional set mode. In this example, the help screen remains active while button “D” is activated, and the help screen is deactivated (e.g., removed from the display) when the “D” button is released.

The selectors are arranged such that the electronic device accomplishes navigating and selecting content on each channel in a simple manner. An optional fifth selector (e.g., button “E”) may be arranged to provide other functions such as backlighting or another desired function. Other selectors may also be included. For example, an optional sixth selector (not shown) may be arranged to operate as a “channel back” function such that navigation through channels may be accomplished in a forward and reverse direction.

Traffic Channel

The traffic channel is arranged to provide a user of a mobile electronic device simple access to travel related information. The travel information may include information such as incident reports, current traffic conditions, times to travel selected routes, public transportation schedules (e.g. for ferry, train, bus), delays and times associated with the public transportation and the like. The travel information is automatically downloaded to the device and may be customized for each electronic device based on user preferences. The user preferences may be provided as information that is retrieved from broadcast transmissions such as described herein.

Users are able to view current traffic information for their region, as well as view current route information for routes which they have selected. Users may also personalize the route information they receive. For example, a user may choose to receive traffic information for their route from home to work, work to home, home to the golf course, and the like. The route information includes information such as how the current traffic drive times on their selected routes compare relative to normal travel times on the route.

Traffic incidents may also be provided through the traffic channel. Traffic incidents include information such as: location, type, severity, and the like.

While traveling, users can receive default routes for the cities they are traveling in (e.g. airport to downtown) without having to specifically request the route information.

Exemplary Displays

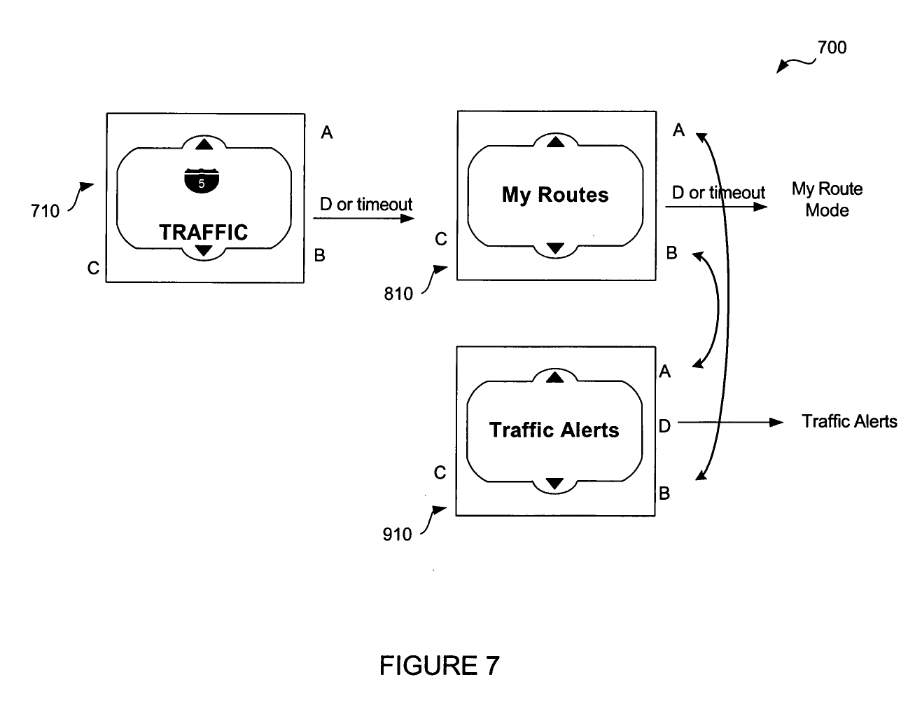

FIGS. 7-15 are diagrams illustrating example views for various modes associated with a traffic channel that is arranged in accordance with the present invention.

FIG. 7 shows an exemplary traffic channel, in accordance with aspects of the invention. The traffic channel may be configured for multiple operating modes. According to one embodiment, the traffic channel includes two modes: a my routes mode and a traffic alerts mode. More or fewer modes may be configured for the channel. For example, the traffic channel could include modes for routes, alerts, general traffic conditions, ferry waits, and the like.

Traffic channel splash-screen 710 is displayed when the traffic channel is initially selected.

After the traffic channel is selected, a view is activated by the expiration of a timeout period (e.g., two seconds) without user interaction, or by activation of the “D” or “enter” selector. The channel splash can be activated from any one of the mode splash screens by activation of the “C” selector.

A mode splash-screen is displayed whenever the mode is changed on the device. In one example, the mode may be changed by selective activation of the next and previous selectors (e.g., the “B” and “A” buttons) when any mode splash screen is active. The mode splash screen may be dismissed via a timeout condition or by activation of the “D” selector (or enter function). Each mode has a series of associated views. The channel splash-screen is dismissed after a mode is activated.

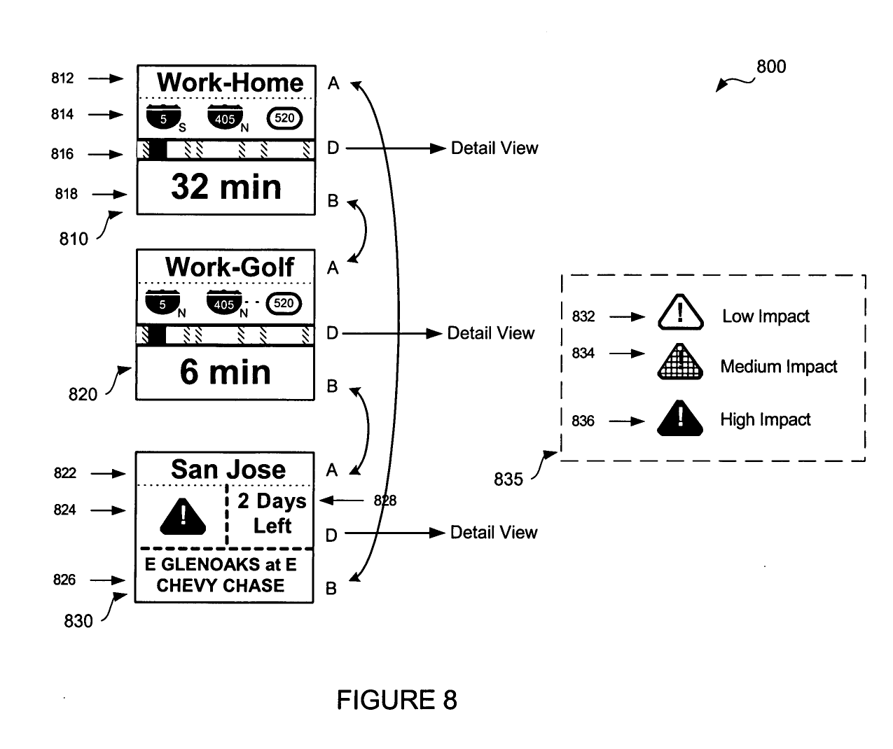

When the my routes mode is activated, my routes splash screen 810 is displayed. After the my routes splash-screen is dismissed, the device enters the my routes mode. According to one embodiment, the my routes splash screen is not displayed before the device enters the my routes mode. Generally, the my routes mode allows a user to view travel conditions relating to traffic routes the user has defined (See FIG. 8 and related discussion).

When the traffic alerts mode is activated, traffic alerts splash screen 910 is displayed. After the traffic alerts splash-screen is dismissed, the device enters the traffic alerts mode. Generally, the traffic alerts mode allows a user to view travel alerts relating to traffic conditions in their travel area.

FIG. 8 shows glance views associated with a my routes mode for a traffic channel, in accordance with aspects of the invention.

The my routes mode (810) allows a user to view the routes the user has selected to receive on their device. The route starting points and destinations may be configured by the user and/or the routes may be selected from a list of routes available for the user's region.

After selecting the my routes mode (810), a glance view of traffic routes the user has selected is displayed (e.g. 810, 820, and 830). The glance view provides the user with traffic information relating to the route.

The user may navigate through the displays by selecting the previous “A” or next “B” buttons. The previous “A” button sets the view to the previous route. If the currently selected route is the first item of the list then the last item on the list is selected. Similarly, selecting the “B” button advances the selection to the next route. When the selected route is the last route then the first route is selected. If the user is currently viewing the last route, pressing the “B” button moves the user to the first route in the list. According to one embodiment, the device enters an auto-glance mode and automatically cycles through the routes without user interaction. For example, after a predetermined period of inactivity (i.e. 5 seconds) the device displays the next available route. The displays continue to advance until the user selects to view details relating to a particular display.

The my routes mode displays drive time reports showing point-to-point current and average drive times for specified routes. Road incident report views may also be included in the my routes mode. The glance views for the drive time views show the user-defined name of the route, the major roads used in the route, the time it takes to currently travel the route, and detailed traffic flow along the route.

The name of the route appears for each route in title bar 812. This route name may include a text description of the route (e.g. Work-Home), the route names (e.g. 10-405-134), or a title specified by the user when the route is configured. The title of the route may be sent to the device as part of a configuration message.

Beneath the name of the route is a graphical representation of the roads (814). For interstate signs, the road numbers are shown in white, for the state highways, the numbers are shown in black. In the present example, there are three road used in the route including Interstate 5 South, 405 North, and State Route 520.

Screen 820 shows a route that includes more than three roads that are used within the route. According to one embodiment, when there are more than three roads used in the route then not all of the roads are shown in the glance view due to limited screen space. As an alternative, all of the roads could scroll across the screen. According to one embodiment, the first and last roads appear along with the next road that is the longest stretch of road.

A graphical road traffic condition is provided in strip 816. Underneath each road symbol the user can glance to determine the current traffic conditions. Each stretch of road is segmented into a predefined number of sections (e.g. 10). Within each section is a graphical display of the traffic sensor data for that stretch of the road. A clear section indicates traffic is normal, a dithered (“grey”) section indicates traffic is a medium condition, and a black section indicates that part of the road is heavy traffic. Any color scheme, however, could be used. An indication may also be included to specify when the road does not include traffic sensor data.

The current drive time is shown in section 818 of the display. The drive time is the calculated current commute time for the specified route.

The detail view shows the user a more specific breakdown of travel times. The detail view breaks down the travel time per road.

Screen 830 shows an exemplary incident report. Incident views highlight specific traffic incidents along a users routes that can include items such as: accidents, slow downs, event traffic, road construction, and the like. Incidents may also be included for roads within a user's region. Incidents appear after all of the drive time items. Each incident includes an area, severity, specific location, estimated end time, type, and text description.

The glance view for incidents shows an image representing the location of the incident (822), the severity (824) of the incident, the time until the incident will be cleared (828), and the location of the incident (826). The type of incident may also be shown. The estimated end time (828) is presented to the user as “time until the incident should be cleared.” The estimated end time is calculated by the device by subtracting the broadcasted estimated end time from the current time.

Box 835 shows exemplary severity indicators. Low impact symbol 832 is for any incident that is indicated by the feed as having low severity. The triangle is white and the exclamation point is black.

Medium impact symbol 834 is for any incident that is indicated by the traffic feed as having medium severity. The triangle is grey (shown as hatched) and the exclamation point is black.

High impact symbol 836 is for any incident that is indicated by the traffic feed as having high or unknown severity. The triangle is black and the exclamation point is white. Other symbols may also be used to indicate the severity.

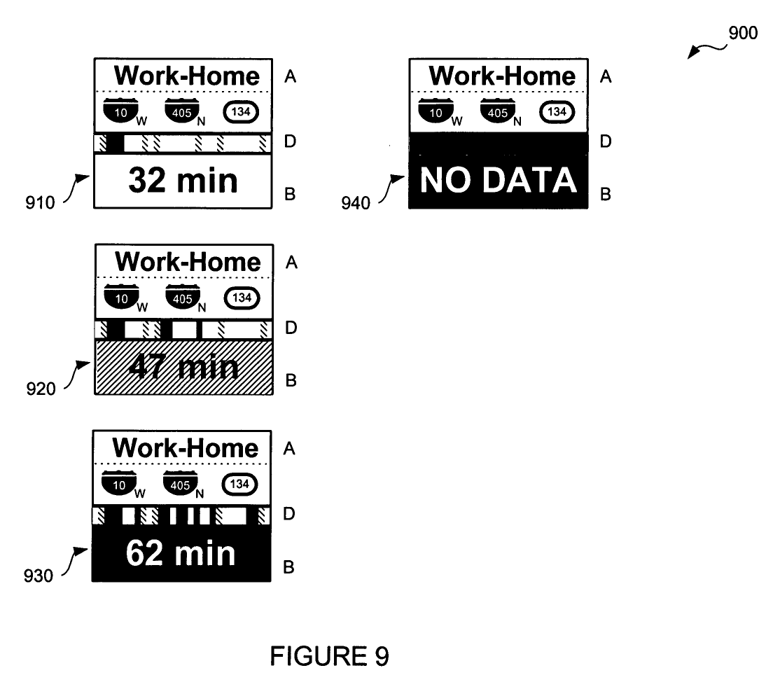

FIG. 9 illustrates traffic conditions, in accordance with aspects of the invention. Each drive time display may include a graphic that may be quickly interpreted by the user to indicate the current traffic conditions on a route.

Display 910 shows a normal traffic condition. In normal traffic, the commute time shows in black print with a clear background.

Display 920 shows a medium traffic condition. In medium traffic, the commute time shows in white with a grey or dithered background.

Display 930 shows a heavy traffic condition. In heavy traffic, the commute time shows in white with a black background.

When a drive time can not be calculated, a NO DATA indication is shown in the display (See 940).

According to one embodiment, the following equations are used to determine if the current drive time is a normal traffic condition, a medium traffic condition, or a heavy traffic condition. For normal traffic the current drive time<=(1.1*Average Time). For medium traffic: (1.1*Average Time)<current commute time<=(1.4*Average Time) and for heavy traffic: current commute time>(1.4*Average Time).

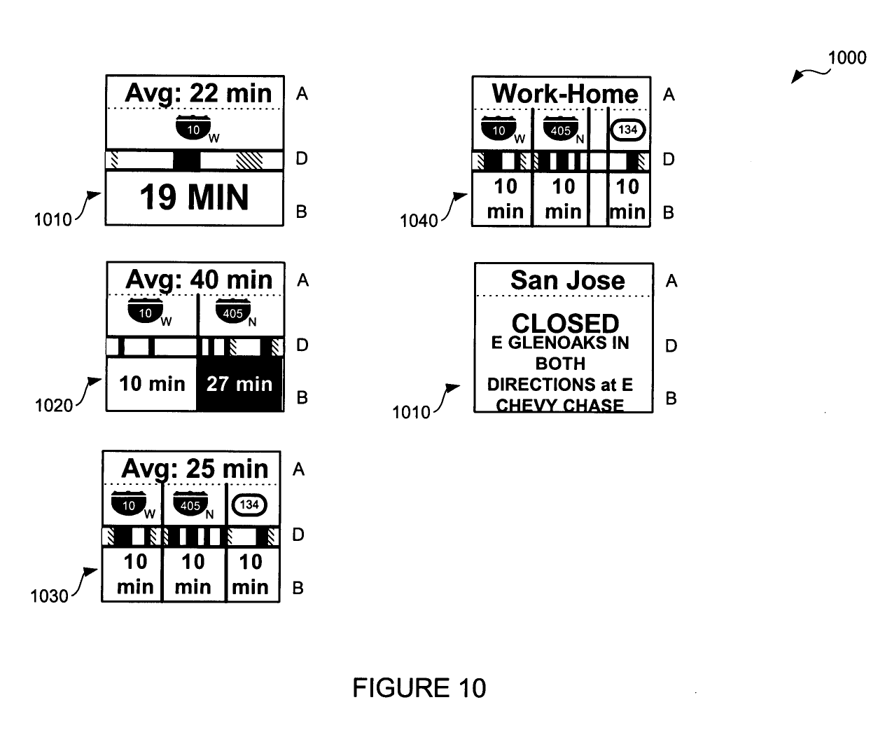

FIG. 10 illustrates detail views for the traffic channel, in accordance with aspects of the invention.

The user may enter a details view by selecting the “D” button while on a selected route or incident. The details view provides the user with more detailed traffic information.

When the user selects the detail view for one of their routes, the user is shown a more specific breakdown of the travel time. Screen 1010 shows a detail view for a single road. Screen 1020 shows a detail view for two roads. Screen 1030 shows a detail view for three roads. Along with the actual current drive time, the average drive time for the route is displayed in the title bar. The average drive time is based on historical times for the route. Screen 1040 shows a detail view for more than three roads.

Screen 1050 shows a detail view for an incident report. The titlebar for incidents details view also shows the name of the area. The top line of the incident detail view shows the type of incident. The text of the incident is plain text that describes the basic details of the incident. When the description extends over multiple pages the user may use the next and previous buttons to scroll through the incident.

Traffic Channel Customization

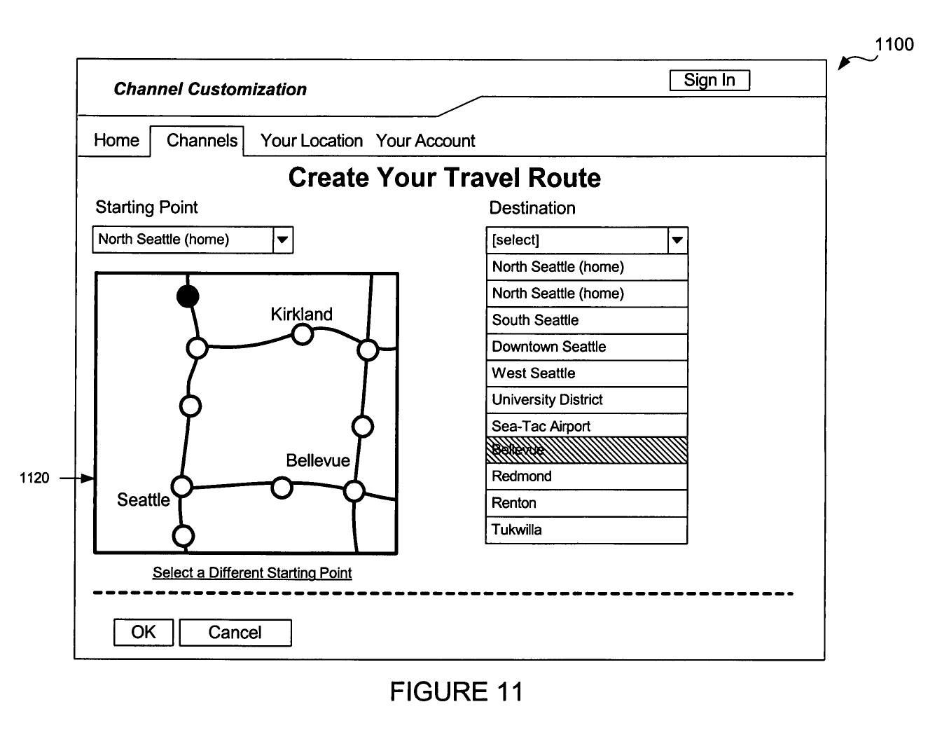

FIGS. 11-13 illustrate web user interfaces for customizing the traffic channel, in accordance with aspects of the invention.

Traffic channel preferences can be modified via a computer type interface such as through an internet based application, a computer based application, or any other reasonable method of accessing and altering configuration information. In one embodiment, a subscriber to the traffic channel can accesses web pages to select or change various features associated with the traffic channel.

FIG. 11 illustrates configuring travel routes, in accordance with aspects of the invention.

As illustrated, web page 1100 allows the user to pick from a set of pre-selected start points and destinations to build their travel routes. According to one embodiment, the available routes are based on the traffic sensors within the user's home region.

Initially, screen 1100 contains a starting point dropdown list and a destination dropdown list. The dropdowns are populated with locations in a region that include drive time sensors on the roadways.

After a user selects a starting point from the starting point drop down list, a map is displayed showing the default starting point for that area (120). Alternatively, a user may select a different starting point from that area using the map. The circles on the map indicate sensor locations for that region. A user may select a location for the starting point or destination by clicking on any of the circles on the map. Hovering over one of the sensors may show the name of the sensor (e.g. Exit 28, Overlake St.). Clicking on the circle will turn the circle a color indicating that the sensor is a starting point or a destination. As illustrated, a circle in North Seattle has been selected as a starting point.

The user selects a destination from the destination drop down list. As illustrated, the user is selecting Bellevue as the destination.

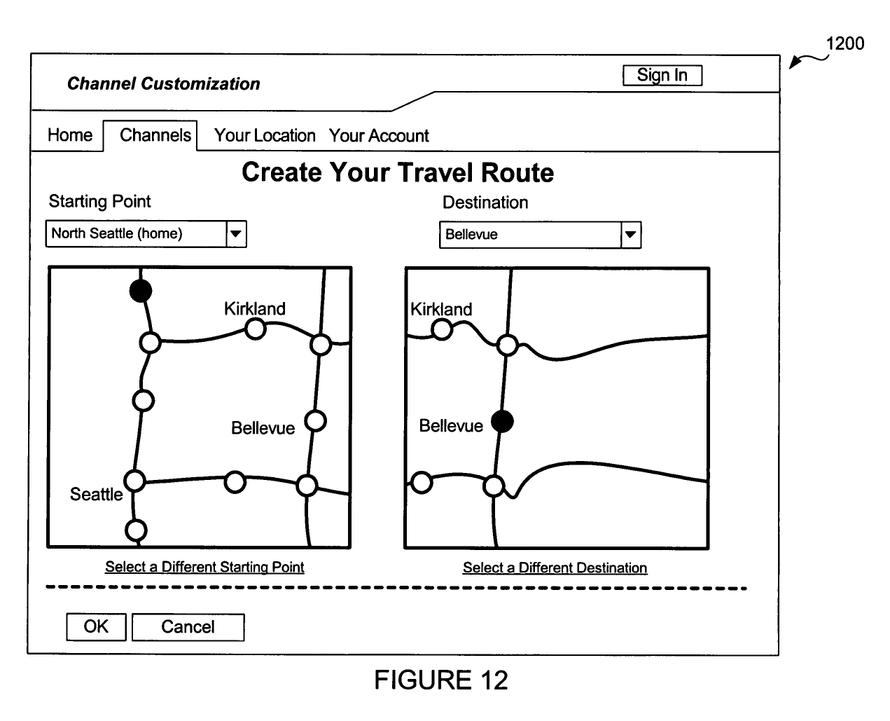

FIG. 12 illustrates selecting a destination, in accordance with aspects of the invention. Screen 1200 shows a map of the starting point area and the destination point area. The user may update either of these locations by selecting one of the circles on the respective map. Once the user is satisfied with their starting point and destination, selecting the OK button calculates the available routes.

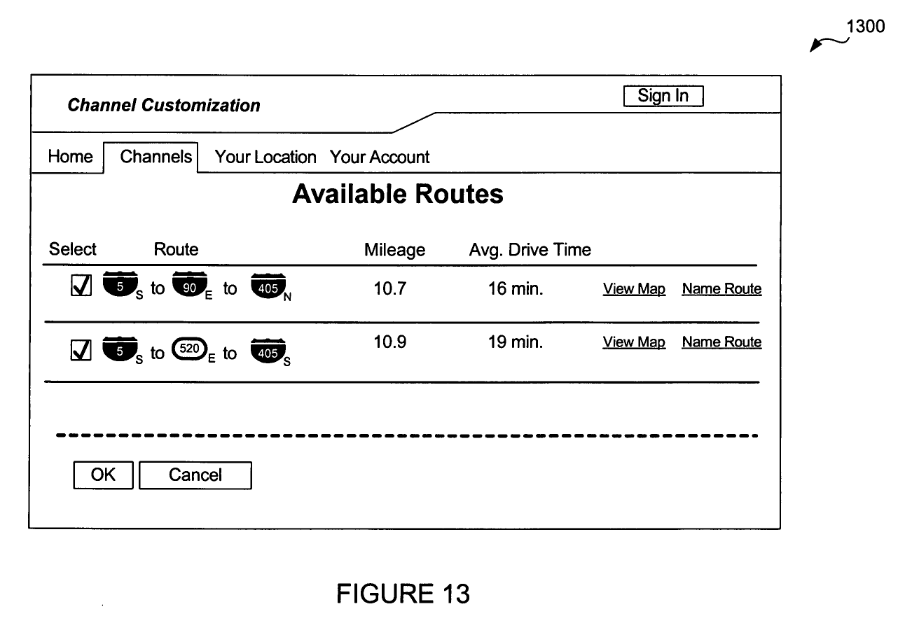

FIG. 13 illustrates a web interface for selecting a calculated route, in accordance with aspects of the invention. As illustrated, screen 1300 shows two different routes between North Seattle and Bellevue that have been calculated. The user may select to receive either or both of these routes on their device by checking the selection box next to the route.

Creating the list of available routes is based on the map of sensors for a region. According to one embodiment, for each region, a tree of connected sensors is created. The tree is a “map” of sensors that can be used to programmatically determine the possible paths between the starting point and the destination.

The mileage and average drive time displayed in screen 1300 is computed from the sensors selected.

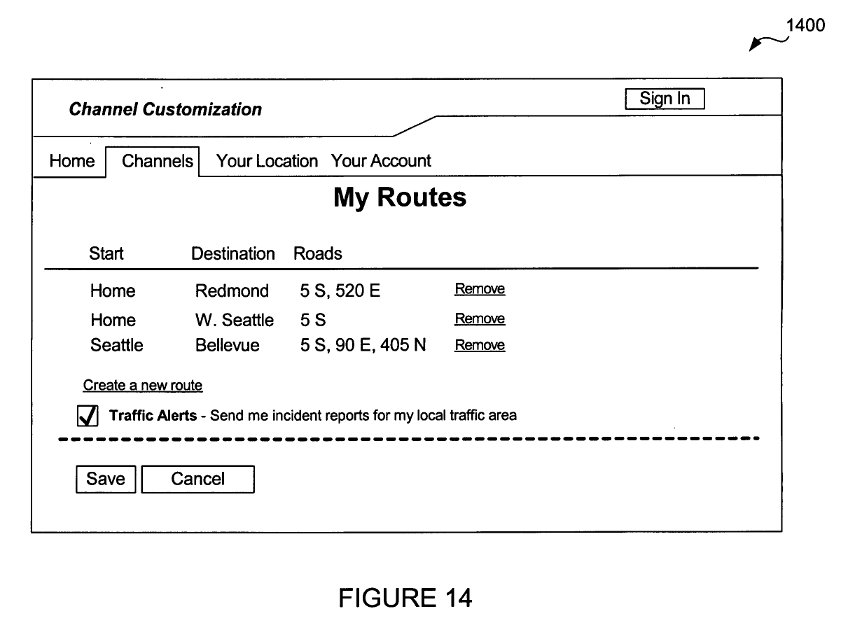

FIG. 14 illustrates a user's selected routes, in accordance with the present invention. Screen 1400 includes information on the user's selected routes such as the starting point and destination along with the roads used for each route. When a user selects the remove link the route is removed from the user's device. Interface 1400 also allows the user to select to receive traffic alerts for incidents in their local traffic area.

Traffic Alerts

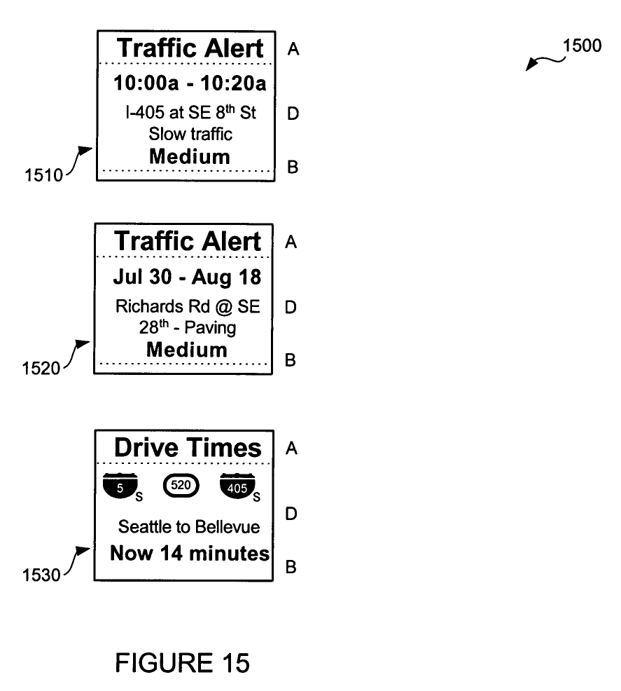

FIG. 15 illustrates displays for traffic alerts and drive times, in accordance with aspects of the invention.

A user may select to receive traffic alerts for incidents in their area and/or other selected areas. According to one embodiment, the user may select up to five areas within their region. The traffic alerts (1510, 1520) show traffic information for the regions the user has selected.

The drive time reports (1530) may include preconfigured drive times from one area to another within the region. Typically these drive times will be the most heavily traveled routes within a region.

Encoding

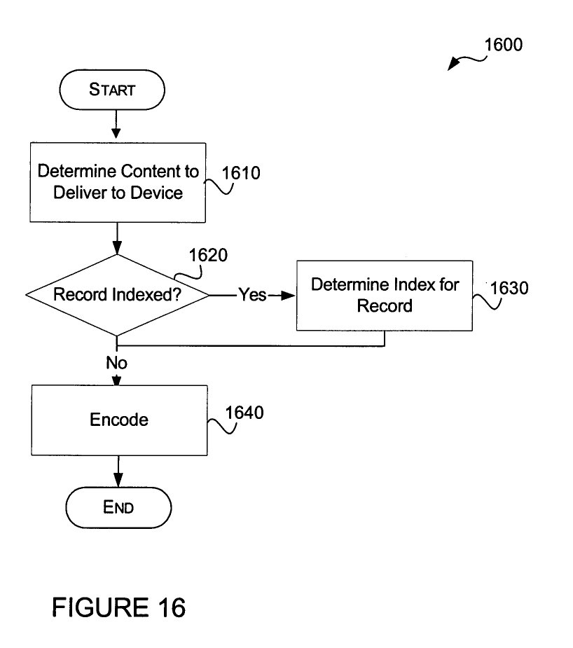

FIG. 16 illustrates encoding traffic data, in accordance with aspects of the invention. After a start block, the process moves to block 1610 where a determination is made as to what content is going to be delivered to the device.

Moving to decision block 1620, a determination is made as to whether the data record is part of an index. Generally, any information that is static and that is broadcast multiple times is encoded as an index. For example, traffic sensors for a region are encoded as part of an index, such that each sensor name does not need to be delivered to the device each time the sensor is referenced. Other traffic information that may be indexed includes road names, city names, and predefined route names. Indexing the content dramatically cuts down the amount of data that needs to be broadcast. The content is indexed by assigning an ID to each name that remains static. According to one embodiment, the index starts at one and ends at the last sensor. The names and their associated IDs are delivered to the device in a configuration message such that when the device receives a traffic broadcast the device may associate the ID with the traffic information. This way, the device can filter the traffic data and piece together the personalized route by assembling data from only the appropriate sensors.

When the record is encoded as an index, the process moves to block 1630, where the index value is determined for the record.

When the record is not encoded as an index, the process moves to block 1640, where the record is encoded. According to one embodiment, the speed recorded by the sensor is stored within a predetermined number of bits. For example, the speed may be encoded in 7 bits, the location in 10 characters, and the like.

Operating Environment

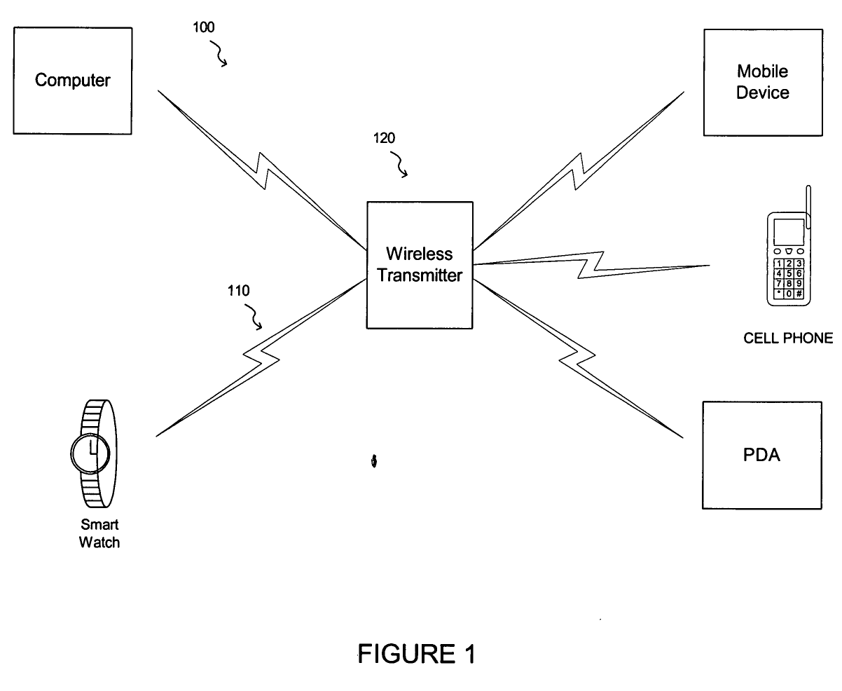

FIG. 1 illustrates an example operating environment for the present invention. As illustrated, operating environment 100 includes wireless transmitter 120 that is responsible for delivering content to wireless devices. According to one embodiment, the wireless transmitter may include a cellular tower that is used to communicate with mobile devices, such as cell phones, notebooks, pocket PCs, long-distance communication links, and the like. According to another embodiment, the wireless transmitter may include an FM transceiver that broadcasts signals over communication channel 110 to the various electronic devices. The FM broadcast may be any number of types including but not limited to: a standard FM transmission, a sub-carrier FM transmission, or any other type of FM transmission as may be desired. Example electronic devices that have an FM receiver or transceiver may include a desktop computer, a watch, a portable computer, a wireless cellular telephone (cell phone), and a personal data assistant (PDA). The electronic devices are arranged to receive information from the wireless broadcast.

Some example electronic devices that may include an electronic system arranged to operate according to the interaction model are illustrated in FIG. 1. Each of the electronic systems receives messages/information over the communication channel.

According to one embodiment, each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., a wireless watch device) receive message packets according to shared and private messages that are directed to the client device. Message packets are organized in groups according to logical slot (or channel) entry numbers. For example, a particular electronic device is configured to receive a selected group of channels from the available channels. The message packets associated with each of those channels is received, processed, and stored in the client device. The stored message packets can be reviewed using a user interface that employs an interaction model, in accordance with the present invention.

Example channels include: a traffic channel, a stocks channel, a news channel, a sports channel, a time channel, a messages channel, a calendar channel, a weather channel, and a movies channel. Messages associated with each channel include message content that is based on the particulars of the channel.

FIG. 2 is a schematic diagram illustrating functional components of an illustrative electronic device that may be used to interact with channel content, in accordance with aspects of the invention. Electronic device 200 includes processor 260, memory 262, display 228, and user interface 232. Memory 262 generally includes both volatile memory (e.g., RAM) and non-volatile memory (e.g., ROM, Flash Memory, or the like). Electronic device 200 may include an operating system 264, such as the Windows CE operating system from Microsoft Corporation or another operating system, which is resident in memory 262 and executes on processor 260. User interface 232 may be a series of push buttons, a scroll wheel, a numeric dialing pad (such as on a typical telephone), or another type of user interface means. Display 228 may be a liquid crystal display, or any other type of display commonly used in electronic devices. In one example, display 228 may be touch-sensitive that would act as an input device.

One or more application programs 266 are loaded into memory 262 and run on the device. Examples of application programs include traffic programs, news programs, time programs, and so forth. Electronic device 200 also includes non-volatile storage 268 that is located within memory 262. Non-volatile storage 268 may be used to store persistent information which should not be lost if electronic device 200 is powered down. Applications 266 may use and store information in storage 268, such as traffic content used by a traffic application, appointment information used by a calendar program, and the like.

Electronic device 200 includes power supply 270, which may be implemented as one or more batteries. Power supply 270 might further include an external power source, such as an AC adapter or a powered docking cradle that supplements or recharges the batteries.

Electronic device 200 is also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived content. Electronic device 200 can control each alert mechanism separately (e.g., audio, vibration, as well as visual cues).

Electronic device 200 also includes a communication connection, such as radio interface layer 272, which performs the function of receiving and/or transmitting radio frequency communications. Radio interface layer 272 facilitates wireless connectivity for electronic device 200. Transmissions to and from radio interface layer 272 are conducted under control of the operating system 264. In other words, communications received by radio interface layer 272 may be disseminated to application programs 266.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are included within the scope of computer readable media.

In one example of the present invention, electronic device 200 is a mobile electronic device such as a watch device that includes a wireless interface. An exemplary watch device is shown in FIG. 3.

Broadcast Channels

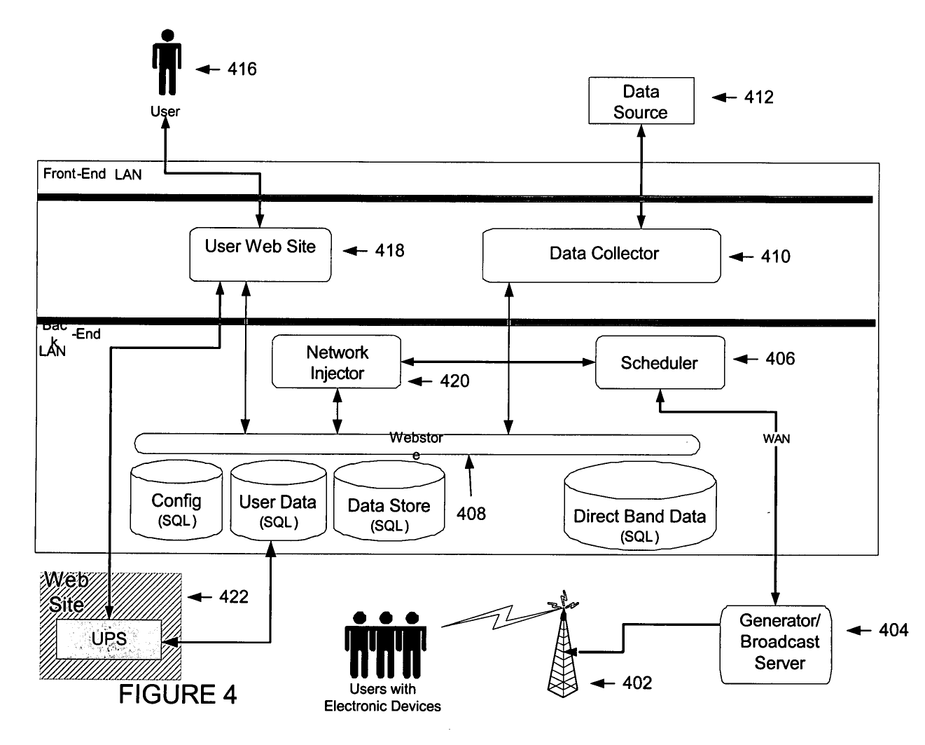

FIG. 4 illustrates a system for delivering and configuring channel information to an electronic device, in accordance with aspects of the invention.

A user, such as user 416, may customize their channels through user web site 418. Using website 418 the user may set options and select information associated with channels to which they have subscribed. For example, the user may configure the routes and traffic information which are provided to the electronic device. The selected options are stored in a data store, such as webstore 408. Channel information and various options may also be automatically retrieved from a web site to which the user participates in. For example, web site 422 may be the user's home page in which the user has already selected various options customizing their page. These options may be used to populate the options associated with various channels. For example, a user's home location and work location could be used to calculate a route, a user's tracked stocks may be used in a stocks channel, a user's selected cities may be used in a weather channel, the user's selected theaters may be used in a movies channel, a user's news sources may be used in a news channel, and the like.

Data Collector 410 is configured to collect data from one or more data sources, such as data source 412, relating to a channel. For example data collector 410 may retrieve traffic sensor data from one data source, and incident reports from another data source.

According to one embodiment, the data collector obtains the sensor data and incident reports from a single data provider named TeleAtlas North American (TANA). TANA provides individual traffic incident reports/alerts as well as flow data for various regions. The traffic information may also be obtained from other sources such as individual state department of transportation entities.

Sensor information includes information such as the latitude, longitude, direction, time data was obtained, whether the sensor is located in a high occupancy lane, and speed values. Using this information, along with the corresponding travel distances between sensors on a route the current drive time may be calculated.

According to one embodiment, the calculation of the drive time is performed on the device. During configuration, the device is sent a configuration message which includes the sensors on each route selected by the user along with the distance, in miles, between each sensor. To calculate the average drive time, the device assumes that the distance from half way from the previous sensor, through this sensor, up to half way to the next sensor is constant at the speed reported by the sensor. Therefore, the time required to travel along one sensor is provided by the following equation: Sensor_speed*(½(distance from prev_sensor to this_sensor)+½(distance from this_sensor to next sensor)). For the first and last sensors on the route, the time is: First sensor=sensor_speed*(½(distance from this_sensor to next_sensor)); Last sensor=sensor_speed*(½(distance from prev_sensor to this_sensor)).

Data collector 410 may also check the sensor data for validity. For example, if a speed value is missing or if the speed is in excess of 120 MPH or below 1 MPH, the sensor data may not be valid. If sensors are missing or inaccurate for more than 30 minutes, the data collector provides a warning.

According to one embodiment, when a sensor is determined to be bad because of no data or invalid data then when the sensor has sensors located within two miles of it in both directions, the speed at the bad sensor is considered the average of the two sensors next to it. If there are multiple sensors that are considered bad, or if the sensors are too far apart, then an error is sent to the device and the device reports the current drive time as “NO DATA.”

Another alternative is to use historical data to replace the value of a bad sensor.

As discussed above, each device receives a configuration message when a change is made to the traffic channel. According to one embodiment, the following is an exemplary configuration message sent for each drive route.

| Data | Encoding |
|---|---|
| Name of Route | Up to 10 Chars |
| Sensor IDs | Index location |
| For each sensor ID, the number of | Number range from .1 to 10 |
| miles from ½ way from the previous | |
| sensor to ½ to the next sensor | |

According to one embodiment, sensor data is broadcast approximately every 5 minutes to the devices.

Average drive times for each route may be dynamically calculated from historic data each day. According to one embodiment, five different samples of average drive times are calculated and include an average for the: Morning Rush (6:00 am-9:00 am M-F); Daytime (9:00 am-4:30 pm M-F); Evening Rush (4:30 pm-7:00 pm M-F); Night time (7:00 pm-6:00 am M-F); and Weekends (6:00 am Saturday to 6:00 am Monday). These times may be adjusted based on the region.

Data collector 410 may store the data in a data store, such as webstore 408, for later broadcast. According to one embodiment, data store 410 communicates with network injector 420 which then stores the data in webstore 408.

Broadcast transmitter tower 402 is arranged to provide a communication signal that is configured for reception by users with electronic devices that are located within a service region. Broadcast tower 402 transmits in response to generator/broadcast server 404. Generator 404 may communicate with scheduler 406 via a network communication link. Scheduler 406 is configured to schedule broadcast transmissions relating to channel information. The traffic data may be broadcast more frequently during rush hour. The device can also receive data and determine how long the data is valid. This information may be included in the application on the device, or encoded in the data sent to the device. For example, incident data includes an estimated completion time that may be used to remove the data. This helps the device save resources by not having to repeatedly download the same data.

Selected services are entered in a database, such as webstore 408 for broadcast transmission at a later time. At the designated time (or time interval) scheduler 406 communicates with broadcast server 404 to begin a transmission sequence of data for the selected services. Broadcast server 404 converts the data to the appropriate format for transmission (i.e. an FM signal) and relays it to broadcast tower 402. In an alternative example, scheduler 406 communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region receives the shared and personal messages. Personal messages, however, may only be decoded by a single client.

Each frame includes a header, a table of contents, and a message payload that includes the content for one or more selected services as previously described. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust any time related information. Moreover, the time and date functions of the client device may be synchronized based on information that is included in the broadcast transmissions.

According to one embodiment, sensor names change fairly rarely and therefore are sent by broadcast server 404 as part of the configuration of the traffic channel on the electronic device. The electronic device stores the name and corresponding ID of the sensor such that when it receives a traffic broadcast transmission the device may match the ID with the name of the sensor. Whenever a sensor name changes a configuration message is prepared and sent to users who are in the region of the sensor. Alternatively, the sensors may be included in a broadcast stream.

As discussed above, the sensor data for an entire region is broadcast to each device. Each device may then retrieve the sensor data it uses within its routes in order to assemble the route information it needs.

Process Flow

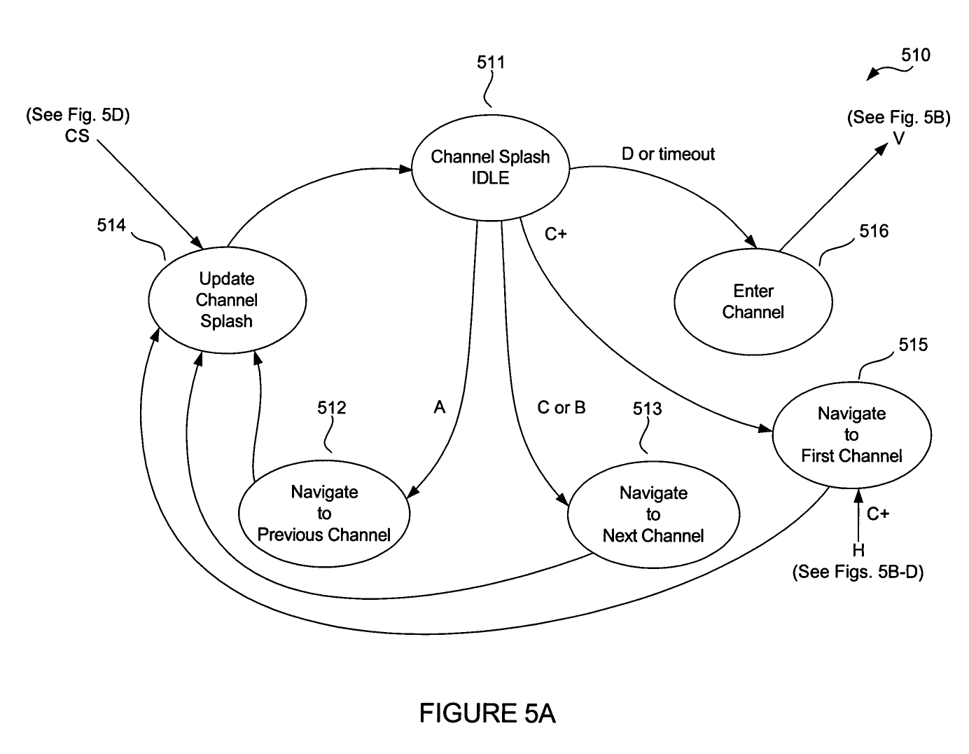

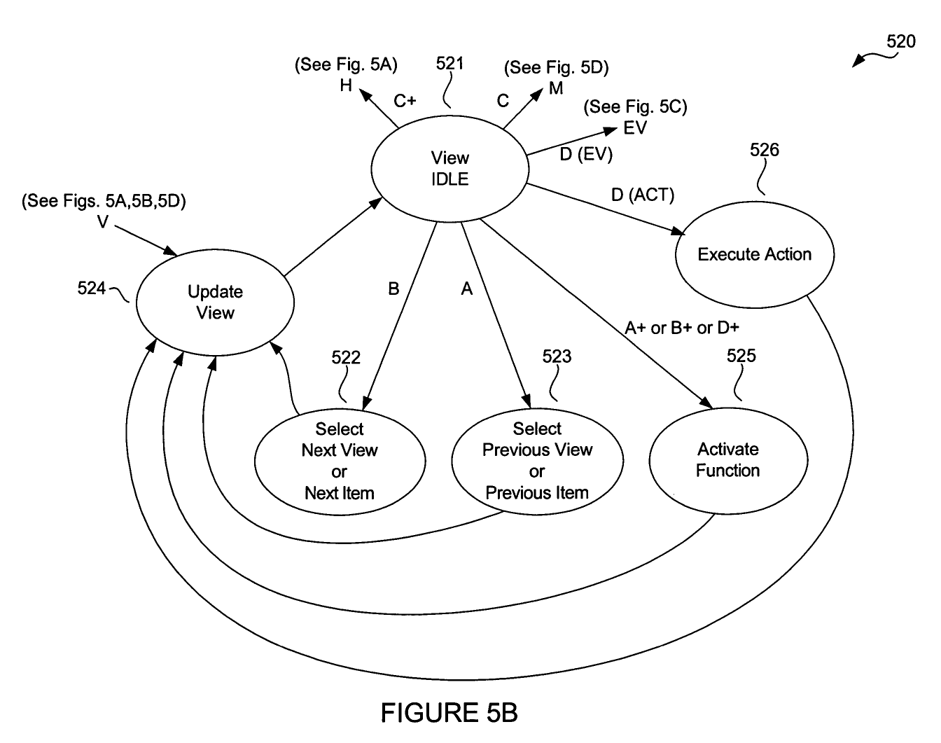

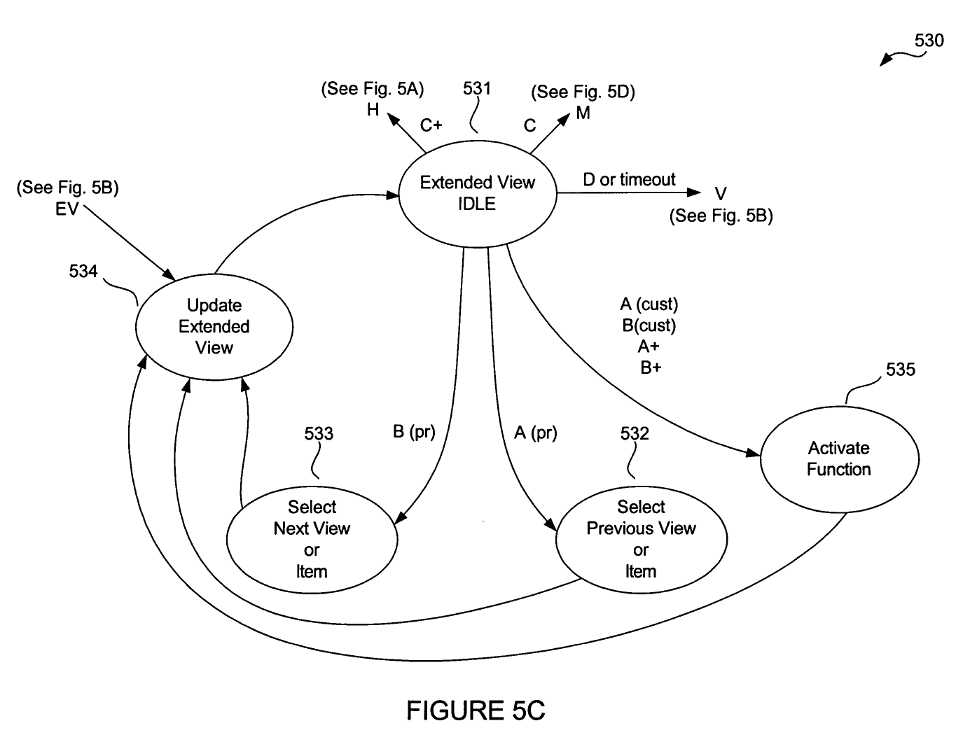

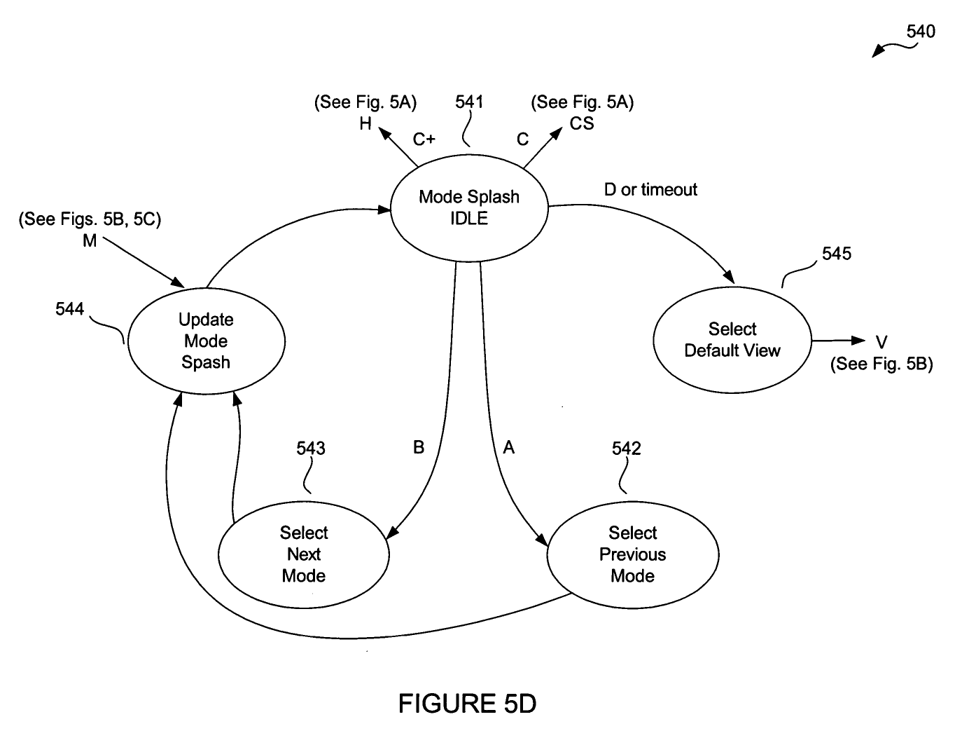

Process flow diagrams for navigation function of an example electronic device are illustrated in FIGS. 5A-5D. The process flow diagram illustrated in FIG. 5A is predominately focused on channel splash activity. The process flow diagram illustrated in FIG. 5B is predominately focused on view activity. The process flow diagram illustrated in FIG. 5C is predominately focused on extended view activity. The process flow diagram illustrated in FIG. 5D is predominately focused on mode splash activity.

Every electronic device has at least one channel that corresponds to the home channel. For a watch type of device, the home channel corresponds to a time channel. However, different home channels can be assigned to every electronic device. Whenever the currently selected channel corresponds to the home channel, the previous channel corresponds to the last channel (if more than one channel exists on the device). Similarly, the next channel corresponds to the home channel when the current channel is the last channel in the channel list for the electronic device.

Every electronic device has a set of selectors (or buttons) that are selectively activated to navigate various functions in the device. Example selectors are illustrated in FIG. 3. For the purposes of the discussion below, each selector is indicated by a letter such as “A”, “B”, “C”, “D”, and “E”. Some alternate selector functions may be chosen by sustained activation of a selector button for a predetermined time interval (e.g., two seconds). The alternate selector functions are generally indicated in the figures by a “+” symbol that is adjacent to the selector functions' designating letter (e.g., “C+”).

The example electronic device described below includes at least four selectors as indicated by letters “A”, “B”, “C”, and “D”. The “E” selector may be arranged to provide additional functions such as backlighting, a back channel selector, as well as any other desired function. Additional extended functions may also be programmed and accessible through multiple selector combinations. For example, one function could be selected by holding the “D” and “A” selectors together (“D+” & “A+”) for a predetermined time interval. Additional extended functions can also be programmed using other selector combinations such as “D+” & “B+”, “A+” & “B+”, as well as others.

Channel Splash Operating State

The channel splash operating state is described as follows below with reference to FIG. 5A.

The electronic device has a default initial channel that is referred to as a home channel. The display is updated to indicate the currently selected channel at block 514. Processing continues to block 511 where the channel splash operating state is maintained in an idle state. The electronic system in the electronic device monitors the user interface (e.g., the four selectors) while in the channel splash IDLE state. Processing leaves the channel splash IDLE state when the user activates one or more of the selectors or a timeout has occurred. The display actively maintains the splash screen to indicate the current channel selection while the channel splash IDLE state is active at block 511. Splash screens may include one or more graphic elements and/or text elements. An example channel splash screen for a traffic channel is illustrated in FIG. 7. Splash screens may be accompanied by the activation of sound that provides an audible indicator that the channel has changed. The sound associated with the audible indicators may be the same for each channel splash screen, or unique based on either the particular channel or the particular channel type (e.g., traffic channel is one type, while messages are another type).

Processing flows from channel splash IDLE state 511 to the “navigate up” or “navigate to previous channel” function 512 when the “A” selector is activated. Processing continues from block 512 to block 514, where the display is updated based on the newly selected channel. After the display is updated, processing returns to channel splash IDLE state 511.

Processing flows from channel splash IDLE state 511 to the “navigate down” or “navigate to next channel” function 513 when either the “B” selector or the “C” selector is activated. Processing continues from block 513 to block 514, where the display is updated based on the newly selected channel. After the display is updated, processing again returns to channel splash IDLE state 511.

Processing flows from channel splash IDLE state 511 to the “navigate to first channel” or “navigate to home channel” function 515 when the “C+” selector is activated. The home channel navigation function can be accessed from any channel of the electronic device. The electronic device navigates to the home channel (e.g., the time channel on a watch device) when the “navigate to home channel” function is activated. Processing continues from block 513 to block 514, where the display is updated based on the newly selected channel (i.e., the home channel). After the display is updated, processing again returns to channel splash IDLE state 511.

Processing flows from the channel splash IDLE state 511 to the “enter channel” function 516 when the “D” selector is activated. Alternatively, the “enter channel” function is activated when the electronic system is maintained in the channel splash IDLE state for a predetermined time interval (e.g., a 2 second timeout) without activation of a selector. Processing flows from block 516 to block 524 (see FIG. 5B) when the “enter channel” function is activated as indicated by “V”.

The enter channel function performs a series of initializations in the electronic device prior to leaving the channel splash operating state and entering the channel view operating state. Every channel in the electronic device has at least one operating mode. The electronic device selects the current operating mode as a default mode, and a current view as a default view in the currently selected channel when the “enter channel” function is activated.

Channel View Operating State

The channel view operating state is described as follows below with reference to FIG. 5B.

The electronic device enters the channel view operating state at entry point V, where the selector functions associated with the currently selected channel and operating mode are mapped to the selectors. The display is updated to indicate the currently selected view at block 524. Processing continues to block 521 where the channel view operating state is maintained in an IDLE state. The electronic system in the electronic device monitors the user interface (e.g., the four selectors) while in the view IDLE state. When the user activates one or more of the four selectors, processing leaves the view IDLE state.

The display actively maintains the current view while the view IDLE state is active at block 521. List type views include lists of items that can be selected. Other types of views are simply graphical and/or textual elements that are arranged in a display view. Views may be accompanied by the activation of sound that provides an audible indicator that the view has changed. The sound associated with the audible indicators may be the same for each view (e.g., a beep type of indicator or sound clip), or unique based on the particular view. In one example, an audible indicator is activated when a particular alert notification function is activated.

Processing flows from the view IDLE state 521 to the “previous view” or “previous item” function 522 when the “A” button selector is activated. Processing continues from block 522 to block 524, where the display is updated based on the newly selected view. After the display is updated, processing returns to view IDLE state 521. In one example, the previous view corresponds to the last view when the currently selected view is the first available view in the current mode for the current channel. In another example, the previous view corresponds to an empty view (e.g., “no sensor data”, “no data”, etc.) when the currently selected view is the first available view in the current mode for the current channel. In still another example, the previous item in a list is highlighted when the “A” selector is activated.

Processing flows from view IDLE state 521 to the “next view” or “next item” function 513 when the “B” selector is activated. Processing continues from block 523 to block 524, where the display is updated based on the newly selected view. After the display is updated, processing again returns to view IDLE state 521. In one example, the next view corresponds to the first view when the currently selected view is the last available view in the current mode for the current channel. In another example, the next view corresponds to an empty view when the currently selected view is the last available view in the current mode for the current channel. In still another example, the next item in a list is highlighted when the “B” selector is activated.

Processing flows from view IDLE state 521 to the “mode splash” function when the “C” selector (e.g., “mode select”) is activated as indicated by “M”. Refer to FIG. 5D and related discussion for details. Processing flows from view IDLE state 521 to the select home channel splash function when the “C+” selector is activated as indicated by “H”. Refer to FIG. 5A and related discussion for details.

The “D” selector is defined within the context of the current channel, mode, and view. The “D” selector may be defined as a “delete” function, and “enter extended view” function, a “select” function, or an “execute action” function. Not every view in a given channel/mode has an extended view as may be indicated by a null value. Some views may have an action function that is defined within the context of the view in the currently selected mode/channel. The context for each view is assigned to the mode upon entry into the mode for the current channel.

Processing flows from the view IDLE state 521 to the “enter extended view” function when the “D” selector is activated and the extended view is available as indicated by “D(EV)”. The extended view is available when defined within the context of the currently selected view. For example, the extended view may be available for a list type view such that the highlighted list item is selected when the “D” selector is activated, and a detailed view associated with the highlighted item is displayed as an extended view. Refer to FIG. 5C and related discussion for details on the extended view processing.

Processing flows from view IDLE state 521 to the “execute action” function at block 526 when the “D” selector is activated and the action function is available as indicated by “D(ACT)”. The action function is defined within the context of the currently selected view. For example, a fortune cookie mode may be available in an entertainment channel. Although the fortune cookie mode may only have a single view, the “D” selector may be mapped to an action function that randomly selects fortunes from a list when the “D” selector is activated. After the action is performed (e.g., retrieve random fortune from list, execute an animation sequence), processing continues to block 524 where the display is updated as previously described.

Other special functions may be mapped to the “A+”, “B+”, and “D+” selectors within the context of the current view. By activating the corresponding selector for a predetermined time interval (e.g., 2 seconds) the corresponding special function is activated as indicated by block 525. Processing continues from block 525 to block 524 where the display is updated as previously described.

In one example, processing may flow from view IDLE state 521 to an “alternate view” function when the electronic system is maintained in the channel splash IDLE state for a predetermined time interval (e.g., a 2 second timeout) without activation of a selector. For example, no action for a predetermined amount of time may result in views associated with the channel automatically rotating to other views associated with the channel.

Extended View Operating State

The extended view operating state is described as follows below with reference to FIG. 5C.

The electronic device enters the extended view operating state at entry point EV, where the selector functions associated with the currently selected extended view are mapped to the selectors. The display is updated to indicate the currently selected extended view at block 534. Processing continues to block 531 where the extended view operating state is maintained in an IDLE state. The electronic system in the electronic device monitors the user interface (e.g., the four selectors) while in the extended view IDLE state. When the user activates one or more of the four selectors, processing leaves the extended view IDLE state.

The display actively maintains the current extended view while the extended view IDLE state is active at block 531. Extended views include graphical and/or textual elements that are arranged in a display view. Extended views may be accompanied by the activation of sound that provides an audible indicator that the extended view has changed. The sound associated with the audible indicators may be the same for each extended view (e.g., a beep type of indicator or sound clip), or unique based on the particular extended view.

Processing flows from extended view IDLE state 531 to the “previous view” or “previous item” function 532 when the “A” selector is activated. Processing continues from block 532 to block 534, where the display is updated based on the newly selected extended view. After the display is updated, processing returns to extended view IDLE state 531. In one example, the previous view corresponds to the last extended view when the currently selected extended view is the first available extended view for the current channel/mode. In another example, the previous extended view corresponds to an empty view (e.g., “no appointments”, “no events”, “no data”, etc.) when the currently selected extended view is the first available extended view in the current channel/mode.

Processing flows from extended view IDLE state 531 to the “next view” or “next item” function 533 when the “B” selector is activated. Processing continues from block 533 to block 534, where the display is updated based on the newly selected extended view. After the display is updated, processing returns to the extended view IDLE state 531. In one example, the next view corresponds to the first extended view when the currently selected extended view is the last available extended view for the current channel/mode. In another example, the next extended view corresponds to an empty view (e.g., “no events”, “no data”, etc.) when the currently selected extended view is the last available extended view in the current channel/mode.

Processing flows from extended view IDLE state 531 to the “mode splash” function when the “C” selector (e.g., “mode select”) is activated as indicated by “M”. Refer to FIG. 5D and related discussion for details.

Processing flows from extended view IDLE state 531 to the view function when the “D” selector is activated as indicated by “V”. In another example, processing flows from extended view IDLE state 531 to the view function when a timeout interval expires (e.g., 5 seconds). Refer to FIG. 5B and related discussion for details concerning the view functions.

Processing flows from extended view IDLE state 531 to the select home channel splash function when the “C+” selector is activated as indicated by “H”. Refer to FIG. 5A and related discussion for details.

Special functions may be mapped to the “A′”, “B”, “A+”, and “B+” selectors within the context of the current view. By activating the corresponding selector for a predetermined time interval (e.g., a 2 second timeout interval) the corresponding special function is activated as indicated by block 535. Processing continues from block 535 to block 534 where the display is updated as previously described.

Mode Splash Operating State

The model splash operating state is described as follows below with reference to FIG. 5D.

The electronic device enters the mode splash operating state at entry point M. The display is updated to indicate the currently selected mode at block 545. Processing continues to block 541 where the mode splash operating state is maintained in an IDLE state. The electronic system in the electronic device monitors the user interface (e.g., the four selectors) while in the mode splash IDLE state. When the user activates one or more of the four selectors, processing leaves the mode splash IDLE state.

The display actively maintains the current mode splash display while the mode splash view IDLE state is active at block 541. Mode splash views include graphical and/or textual elements that are arranged in a display view. Mode splash displays may be accompanied by the activation of sound that provides an audible indicator that the selected mode has changed. The sound associated with the audible indicators may be the same for each mode splash (e.g., a beep type of indicator or sound clip), or unique based on the particular mode selected.

Processing flows from mode splash IDLE state 541 to the “previous mode” function 542 when the “A” selector is activated. Processing continues from block 542 to block 544, where the display is updated based on the newly selected mode. After the display is updated, processing returns to mode splash IDLE state 541. In one example, the previous mode corresponds to the last mode when the currently selected mode is the first available mode for the current channel.

Processing flows from mode splash IDLE state 541 to the “next mode” function 543 when the “B” selector is activated. Processing continues from block 543 to block 544, where the display is updated based on the newly selected mode. After the display is updated, processing returns to mode splash IDLE state 541. In one example, the next mode corresponds to the first mode when the currently selected mode is the last available mode for the current channel.

Processing flows from mode splash IDLE state 541 to the “channel splash” function when the “C” selector (e.g., “channel select”) is activated as indicated by “CS.” Refer to FIG. 5A and related discussion for details.

Processing flows from mode splash IDLE state 541 to the “select default view” function 545 when the “D” selector is activated. Alternatively, processing may flow from mode splash IDLE state 541 to the “select default view” function 545 when a timeout interval (e.g., a 2 second interval) has expired. Processing continues from block 545 to the channel view operating state as indicated by “V”. Refer to FIG. 5B and related discussion for details.

Processing flows from mode splash IDLE state 541 to the select home channel splash function when the “C+” selector is activated as indicated by “H”. Refer to FIG. 5A and related discussion for details.

Example Display Screen Partitions

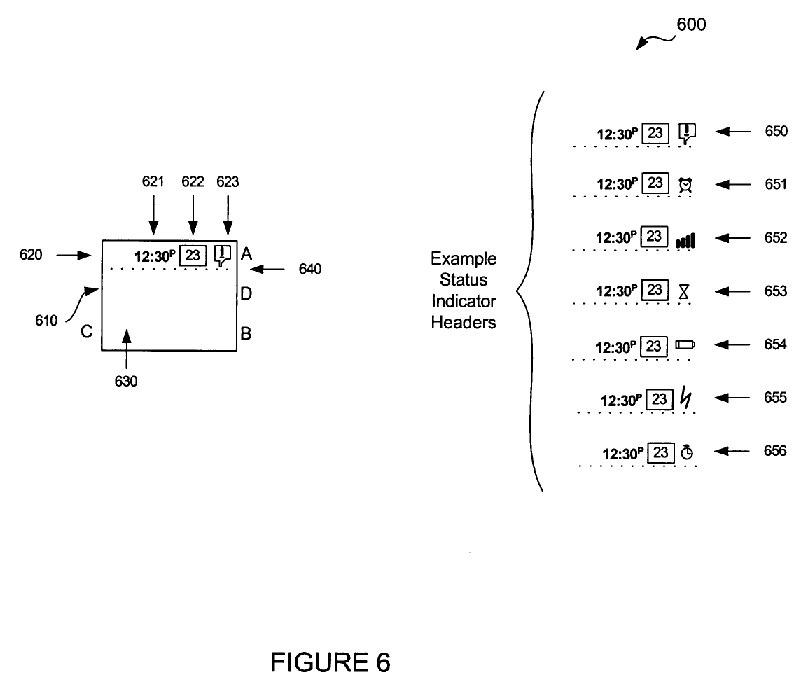

FIG. 6 shows exemplary status indicator headers, in accordance with aspects of the present invention. Example display screen 610 is partitioned into two regions: header region 620 and main body region 630.

Main body region 630 of display screen 610 may include one or more graphical and/or textual information fields that change based on the current context in the current channel, mode, and operating state. In one example context, main body region 630 is a single region for displaying textual information, such as textual information relating to the traffic channel. In another example context, main body section 610 may include a graphical representation.

Header region 620 of display screen 610 may include one or more graphical and/or textual information fields. The fields may change based on the current context in the current channel, mode, and operating state. In one example context, header region 620 may include three regions: current time field 621 and current date field 622. In another example context, header region 620 may include three regions (650): current time field 621, current date field 622, and status indicator field 623. In still another example context, header region 620 may include information relating to the channel. For example, the title of a route may be displayed in header region 620.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for receiving, displaying and interacting with traffic channel content on a mobile electronic device, comprising:
receiving traffic channel content encoded on a communication signal that is broadcast to many electronic devices;
filtering the traffic channel content based on pre-defined traffic preferences associated with the device;
storing at least a portion of the traffic channel content on the electronic device;
associating the traffic channel content with an application on the electronic device;
setting a current view associated with the traffic channel; and
displaying the current view on a display of the electronic device.

2. The method of claim 1, wherein setting the current view, further comprises displaying at least one traffic route that includes information relating to travel conditions for a travel route.

3. The method of claim 2, further comprising determining when a route is selected; and in response to the route being selected showing details associated with the route.

4. The method of claim 2, wherein setting the current view, further comprises displaying an incident report associated with at least one of a route and an area selected by a user.

5. The method of claim 2, wherein the information includes at least one of the following: an average drive time; a current drive time; an indication of the traffic; and roads used within the route.

6. The method of claim 5, wherein the indication of the traffic further comprises showing a bar chart including segments, wherein each segment includes an indication of the traffic flow for the corresponding portion of the route.

7. The method of claim 5, wherein the application is further configured to calculate the current drive time of the route.

8. The method of claim 5, wherein filtering the traffic channel content based on the pre-defined traffic preferences, further comprises determining traffic sensors used within a route selected by the user and storing the corresponding sensor information on the device.

9. The method of claim 4, further comprising showing an area of the incident along with at least one of the following: a location of the incident, a severity;
an estimated duration; an estimated end time; and a text description of the incident.

10. An apparatus for receiving, navigating, and displaying traffic channel content, comprising:
a data store;
a communication connection configured to receive a communication signal including the traffic channel content that is directed to a plurality of mobile electronic devices and select a portion of the traffic channel content based on a configuration of the mobile electronic device to store in the data store;
a display;
a user interface that includes a selector; and
an electronic system that is arranged to interact with the user interface, the data store, the communication connection, and the display, wherein the electronic system is configured to:
filter the traffic channel content based on pre-defined user preferences;
change the current operating mode in response to the selector;
select a current view that is associated with the current operating mode; and
display the current view on the display.

11. The apparatus of claim 10, wherein the electronic system is further configured to activate a routes list in response to the interface selection device when a traffic mode is active, wherein the routes list is organized as a list of routes that are selected based on the pre-defined user preferences, and wherein the selector is configured for selecting one of the routes in the list.

12. The apparatus of claim 11, wherein the electronic system is further configured to set the current view to show at least one of the following when the routes is selected: an average drive time associated with the route; a current drive time associated with the route; an indication of the traffic along the route; and roads used within the route

13. The apparatus of claim 12, wherein the indication of the traffic along the route further comprises showing a graphical representation of the route, wherein the graphical representation includes an indication of the traffic flow for each of the roads that include traffic sensors.

14. The apparatus of claim 12, wherein the electronic system is further configured to calculate at least one of a current drive time and an average drive time.

15. The apparatus of claim 11, wherein the electronic system is further configured to set the current view to show an incident including at least one of the following: a location of the incident; a severity; an estimated duration; an estimated end time; and a text description of the incident.

16. The apparatus of claim 12, further comprising configuring the route through a web-based application.

17. A system for providing and interacting with traffic channel content associated, comprising:
a data collector configured to collect traffic channel content;
a broadcast device configured to transmit a communication signal including the traffic channel content to a plurality of mobile electronic devices at the same time;
a mobile electronic device, having:
a data store;
a communication connection configured to receive the communication signal and select a portion of the traffic channel content based on a configuration of the mobile electronic device to store in the data store;
a display;
a user interface that includes a selector; and
an electronic system that is arranged to interact with the communication connection, the user interface, the data store and the display, wherein the electronic system is configured to:
filter the traffic channel content based on pre-defined user preferences;
select a current view associated with a currently selected channel;
change the current view in response to the selector; and
display the current view on the display.

18. The system of claim 17, wherein the traffic channel content includes at least one of the following: traffic sensor information; incident information; route information, and traffic alert information.

19. The system of claim 18, wherein the electronic system is further configured to display route information for a selected route including a drive time associated with the route and traffic flow information associated with the route.

20. The system of claim 19, wherein the broadcast device is configured to broadcast an FM communication signal.

21. The system of claim 20, further comprising a server configured to receive user preferences associated with users receiving the traffic channel content; wherein the user preferences include preferences related to at least one of the following: configuring routes for a user; selecting incident information, and selecting alert information.

22. The system of claim 20, wherein the broadcast device is further configured to index sensor information and send the sensor names as part of a configuration message to the device such that the device may associated the sensor information in the index with the corresponding sensor name.
